(19) United States
(12) Patent Application Publication
(10) Pub. No.: US 2026/0285680 A1
(43) Pub. Date: Sep. 24, 2026

(54) APPARATUS AND METHOD FOR DIRECT DECOMPOSITION OF HYDROCARBON

(71) Applicant: MITSUBISHI HEAVY INDUSTRIES, LTD., Tokyo (JP)

(72) Inventors: Shigeru Nojima, Tokyo (JP); Takafumi Kubota, Takasago-shi, Hyogo (JP); Hironori Kishi, Tokyo (JP); Hidekazu Nishino, Tokyo (JP)

(73) Assignee: MITSUBISHI HEAVY INDUSTRIES, LTD., Tokyo (JP)

(21) Appl. No.: 19/474,267

(22) PCT Filed: Apr. 12, 2024
(86) PCT No.: PCT/JP2024/014771

§ 371 Date: Oct. 10, 2025

(30) Foreign Application Priority Data
Apr. 18, 2023 (JP) 2023-067976

(51) Int. Cl. C01B 3/26; C01B 32/05

(52) U.S. Cl. CPC C01B 3/26; C01B 32/05; C01B 2203/0227; C01B 2203/0277; C01B 2203/1058; C01B 2203/1064; C01B 2203/1241; C01B 2203/1247

(57) ABSTRACT

In the present invention, an apparatus for direct decomposition of a hydrocarbon directly decomposes a hydrocarbon into carbon and hydrogen using a gas containing methane and a hydrocarbon having two or more carbon atoms as a raw material gas. The apparatus includes: a reformer that houses a first catalyst for methanation of the hydrocarbon having two or more carbon atoms; a reactor which is configured so that a reformed gas flowing out of the reformer flows into the reactor, and which houses a second catalyst that is an iron-based catalyst; a recycling line that connects a produced gas line through which a produced gas flowing out of the reactor flows, to a raw material gas line for introducing the raw material gas into the reformer.

### TECHNICAL FIELD

The present disclosure relates to an apparatus and a method for direct decomposition of a hydrocarbon.

The present application claims priority based on JP 2023-067976 filed in the Japan Patent Office on Apr. 18, 2023, the contents of which is hereby incorporated by reference.

### BACKGROUND ART

Currently, production of various types of energy largely depends on fossil fuels such as petroleum, coal, and natural gas, and from the viewpoint of global environmental conservation and the like, an increase in amount of carbon dioxide emitted by combustion of fossil fuels is regarded as an issue. The Paris Agreement, adopted in 2015, requires reducing the emission amount of carbon dioxide to deal with the climate change issue, and in thermal power plants and the like, reduction of the emission amount of carbon dioxide due to combustion of fossil fuels is an important issue. While a process for separating and recovering the emitted carbon dioxide has been energetically studied, a technique to produce energy without emitting carbon dioxide by using an alternative fuel to fossil fuel has also been studied.

Thus, hydrogen, which is a clean fuel that does not emit carbon dioxide through combustion, has attracted attention as an alternative fuel to fossil fuel. Hydrogen can be produced, for example, by steam reforming methane contained in natural gas. However, in this production method, carbon monoxide is produced as a by-product, and the carbon monoxide is finally oxidized and discharged as carbon dioxide. As a method for producing hydrogen from water without using fossil fuel, a water electrolysis method, photocatalytic method, and the like have been studied; however, these methods require a large amount of energy and are economically problematic.

Meanwhile, a method for producing hydrogen and carbon by directly decomposing methane has been developed. The direct decomposition of methane is characterized in that hydrogen fuel can be produced without emitting carbon dioxide, and while carbon as a by-product is solid and thus can be easily immobilized, carbon itself can be effectively used in a wide range of applications such as electrode materials, tire materials, and building materials. A method for directly decomposing a hydrocarbon into hydrogen and carbon by bringing a supported catalyst into contact with a hydrocarbon gas has been developed, but there has been a problem: carbon, which is a product of a direct decomposition reaction of the hydrocarbon, adheres to the catalyst, and thus that the catalytic activity is reduced in a short time.

In view of this, the applicant of the present disclosure has developed a method for directly decomposing a hydrocarbon into carbon and hydrogen using a catalyst that is an unsupported catalyst of an aggregate of a plurality of iron particles, as described in Patent Document 1. The applicant considers that according to this method, even if carbon, which is a product of the direct decomposition reaction of a hydrocarbon, adheres to the catalyst, the activity is maintained by developing a new active site, and therefore that the activity of this reaction can be maintained for a long time.

### CITATION LIST

### Patent Document

Patent Document 1: JP 7089235 B

### SUMMARY OF INVENTION

### Technical Problem

For example, natural gas is used as a raw material gas for the direct decomposition reaction of a hydrocarbon. The natural gas contains, in addition to methane, saturated hydrocarbons having two or more carbon atoms such as ethane, propane, and butane and unsaturated hydrocarbons having two or more carbon atoms such as ethylene, propylene, acetylene, and butene (hereinafter referred to as “hydrocarbons having two or more carbon atoms”), and these hydrocarbons have higher reactivity than methane, and therefore, at a temperature for causing the direct decomposition reaction of a hydrocarbon, side reactions such as thermal decomposition and polymerization reactions of these hydrocarbons may cause, for example, clogging of piping. When a raw material gas containing a hydrocarbon having two or more carbon atoms is used as a raw material for the direct decomposition reaction of a hydrocarbon, it is necessary to remove the hydrocarbon having two or more carbon atoms from the raw material gas to suppress such a risk.

In view of the above circumstances, an object of at least one embodiment of the present disclosure is to provide an apparatus and a method for direct decomposition of a hydrocarbon, which can suppress the risk caused by side reactions such as thermal decomposition and polymerization reactions of a hydrocarbon having two or more carbon atoms when a raw material gas containing the hydrocarbon having two or more carbon atoms is used as a raw material for a direct decomposition reaction of a hydrocarbon.

### Solution to Problem

To achieve the above object, the apparatus for direct decomposition of a hydrocarbon according to the present disclosure is an apparatus for direct decomposition of a hydrocarbon, which directly decomposes a hydrocarbon into carbon and hydrogen using a gas containing methane and a hydrocarbon having two or more carbon atoms as a raw material gas, the apparatus including: a reformer that houses a first catalyst for methanation of the hydrocarbon having two or more carbon atoms; a reactor which is configured so that a reformed gas flowing out of the reformer flows into the reactor, and which houses a second catalyst that is an iron-based catalyst; and a recycling line that connects a produced gas line through which a produced gas flowing out of the reactor flows, to a raw material gas line for introducing the raw material gas into the reformer. In general, synthesis of methane from hydrogen and carbon dioxide is often referred to as methanation, but in the present disclosure, a reaction in which a hydrocarbon having two or more carbon atoms is converted into methane by reacting the hydrocarbon having two or more carbon atoms with hydrogen is defined as “methanation”.

The method for direct decomposition of a hydrocarbon according to the present disclosure is a method for direct decomposition of a hydrocarbon, which directly decomposes a hydrocarbon into carbon and hydrogen using a gas containing methane and a hydrocarbon having two or more carbon atoms as a raw material gas, the method including: a methanation step of converting the hydrocarbon having two or more carbon atoms into methane; a contact step of bringing a reformed gas obtained in the methanation step into contact with an iron-based catalyst; and a recycle step of supplying a part of a produced gas obtained in the contact step to the raw material gas.

### Advantageous Effects of Invention

According to the apparatus and method for direct decomposition of a hydrocarbon of the present disclosure, when a raw material gas containing a hydrocarbon having two or more carbon atoms is used as a raw material for a direct decomposition reaction of a hydrocarbon, an amount of the hydrocarbon having two or more carbon atoms in the raw material gas can be reduced, and therefore, the risk caused by side reactions such as thermal decomposition and polymerization reactions of the hydrocarbon having two or more carbon atoms can be suppressed.

### BRIEF DESCRIPTION OF DRAWINGS

FIG. 1 is a configuration schematic diagram of an apparatus for direct decomposition of a hydrocarbon according to an embodiment of the present disclosure.

FIG. 2 is a configuration schematic diagram of an experimental apparatus used to perform experiments of Examples.

FIG. 3 is a graph showing experimental results of Example 1.

FIG. 4 is a graph showing experimental results of Example 2.

FIG. 5 is a graph showing experimental results of Example 3.

FIG. 6 is a graph showing experimental results of Example 4.

### DESCRIPTION OF EMBODIMENTS

Hereinafter, an apparatus and a method for direct decomposition of a hydrocarbon according to embodiments of the present disclosure will be described with reference to the drawings. The embodiments described below each illustrate one aspect of the present disclosure, do not limit the present disclosure, and can be changed within the scope of the technical idea of the present disclosure.

### Configuration of Apparatus for Direct Decomposition of Hydrocarbon According to Embodiment of Present Disclosure

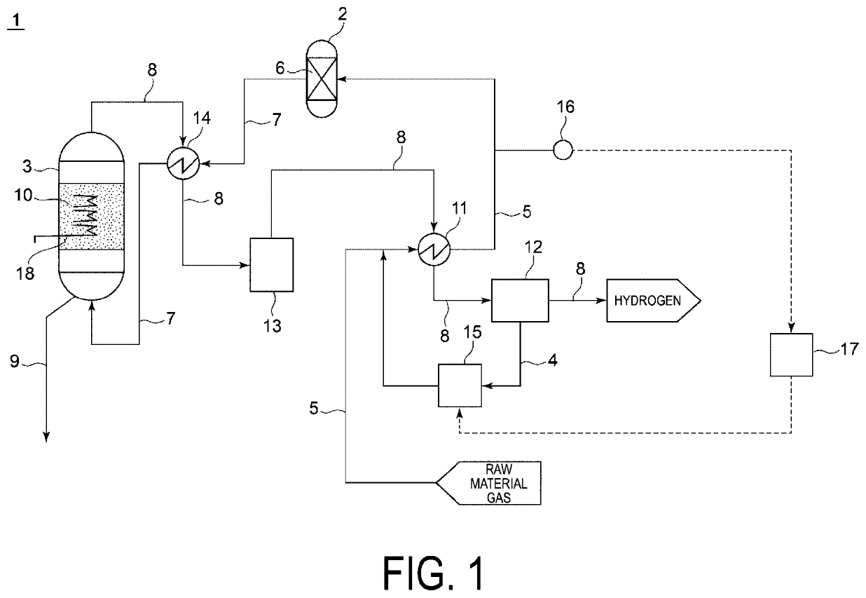

As shown in FIG. 1, an apparatus 1 for direct decomposition of a hydrocarbon according to an embodiment of the present disclosure includes, as essential constituent elements, a reformer 2, a reactor 3, and a recycling line 4 for mixing a part of a produced gas flowing out of the reactor 3 with a raw material gas to be supplied to the reformer 2.

A raw material gas line 5 through which a gas (raw material gas) containing methane and a hydrocarbon having two or more carbon atoms (ethane, ethylene, propane, butane, or the like) flows is connected to the reformer 2. As the raw material gas, for example, natural gas, compressed natural gas (CNG), city gas, liquefied petroleum gas, naphtha, and the like can be used, and in addition, a gas obtained by mixing at least two of these gases at any ratio, a gas prepared by mixing methane gas and a hydrocarbon having two or more carbon atoms at any ratio, and the like can also be used. The reformer 2 houses a first catalyst 6 for methanation of the hydrocarbon having two or more carbon atoms. As the first catalyst 6, any catalyst for methanation can be used, and a supported catalyst in which ruthenium or nickel is supported on alumina can be exemplified.

The reformer 2 and the reactor 3 are connected by a reformed gas line 7. The reactor 3 houses a second catalyst 10 for causing a direct decomposition reaction in which hydrocarbons (methane and a hydrocarbon having two or more carbon atoms) are decomposed into hydrogen and carbon, and hydrogen and carbon are produced in the reactor 3 by an operation described later. The reactor 3 is preferably provided with a heater 18 for raising the temperature of the second catalyst 10. A produced gas line 8 for causing a produced gas containing hydrogen and an unreacted hydrocarbon to flow out of the reactor 3 and a carbon outflow line 9 for causing carbon (including carbon adhering to the second catalyst 10) to flow out of the reactor 3 are connected to the reactor 3. The second catalyst 10 is an iron-based catalyst, and an unsupported catalyst of an aggregate of a plurality of iron particles may be used as an example of the iron-based catalyst, although the iron-based catalyst is not limited thereto. The mechanism of causing the direct decomposition reaction of a hydrocarbon by such an unsupported catalyst is described in detail in Patent Document 1 by the applicant of the present disclosure.

The recycling line 4 is configured to connect the raw material gas line 5 to the produced gas line 8. The produced gas line 8 may be provided with a gas cooler 11 for cooling the produced gas by heat exchange between the raw material gas flowing through the raw material gas line 5 and the produced gas, and a gas separator 12 for separating the produced gas into hydrogen and an unreacted hydrocarbon. As the gas separator 12, a device having any configuration can be used, and for example, a pressure swing adsorption (PSA) type device may be used. When the gas cooler 11 is provided in the produced gas line 8, the recycling line 4 can be configured to be connected to the raw material gas line 5 on an upstream side of the gas cooler 11. When the gas separator 12 is provided in the produced gas line 8, the recycling line 4 can be configured to be connected to the gas separator 12.

Since the produced gas may be accompanied by solid matter such as fine powder of carbon, a solid-gas separator 13 may be provided in the produced gas line 8. The configuration of the solid-gas separator 13 is not particularly limited, and a cyclone, a bag filter, or the like may be used, or a configuration in which a plurality of devices are combined may be used.

The reformed gas line 7 may be provided with a heat exchanger 14 for heating the reformed gas by heat exchange between the produced gas flowing through the produced gas line 8 and the reformed gas flowing through the reformed gas line 7. The reformed gas is a gas flowing out of the reformer 2, and is also a gas in which the concentration of the hydrocarbon having two or more carbon atoms is reduced with respect to the raw material gas by converting the hydrocarbon having two or more carbon atoms in the raw material gas into methane by an operation described later.

The recycling line 4 may be provided with a flow rate adjuster 15 for adjusting the flow rate of the produced gas flowing through the recycling line 4, such as a flow rate adjusting valve or a blower. In addition, the raw material gas line 5 may be provided with a concentration ratio acquisition device 16 that acquires a concentration ratio between the hydrocarbon having two or more carbon atoms and hydrogen in the raw material gas on a downstream side of a connection position where the recycling line 4 is connected to the raw material gas line 5. The concentration ratio acquisition device 16 may be configured by, for example, sensors that detect the respective concentrations of the hydrocarbon having two or more carbon atoms and hydrogen in the raw material gas, and a computer that acquires data of detection values from these sensors and calculates the above-described concentration ratio. In a case where both the flow rate adjuster 15 and the concentration ratio acquisition device 16 are provided, a control system 17 such as a computer is provided, a range of the above-described concentration ratio defined by an upper limit value and a lower limit value is set in the control system 17, and the control system 17 is configured to operate the flow rate adjuster 15 (for example, adjustment of an opening degree of the flow rate adjusting valve or a discharge amount of the blower) such that the detection value by the concentration ratio acquisition device 16 is within the range.

### Operation of Apparatus for Direct Decomposition of Hydrocarbon According to Embodiment of Present Disclosure

Next, an operation of the apparatus 1 for direct decomposition of a hydrocarbon according to an embodiment of the present disclosure (a method for direct decomposition of a hydrocarbon) will be described. The raw material gas flows through the raw material gas line 5 and flows into the reformer 2. In a case where the gas cooler 11 is provided in the raw material gas line 5, the raw material gas flows into the reformer 2 after being heated by an operation described later in the gas cooler 11. Further, a part of the produced gas flowing through the produced gas line 8 is supplied to the raw material gas flowing through the raw material gas line 5 via the recycling line 4 before or after being heated by the gas cooler 11, and is thus mixed with the raw material gas (recycle step in the method for direct decomposition of a hydrocarbon), and flows into the reformer 2.

As described later, since the produced gas contains hydrogen, the mixed gas obtained by mixing the raw material gas and the produced gas flows into the reformer 2, and thus methane and a hydrocarbon having two or more carbon atoms derived from the raw material gas, hydrogen derived from the produced gas, and an unreacted hydrocarbon (described later) that has not been directly decomposed in the reactor 3 are present in the reformer 2.

The hydrocarbon having two or more carbon atoms in the reformer 2 reacts with hydrogen by a catalytic action of the first catalyst 6 and is converted into methane (methanation step in the method for direct decomposition of a hydrocarbon). When ethane, ethylene, propane, and butane are used as examples of the hydrocarbon having two or more carbon atoms, reactions (methanation) represented by the following chemical equations (1) to (4) occur in the reformer 2. The methanation is preferably performed in a temperature range of from 250 to 500° C. and at a space velocity of from 930 to 10000 hr⁻¹.

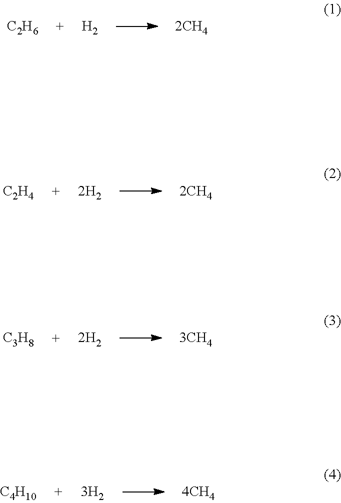

Due to methanation in the reformer 2, the concentration of the hydrocarbon having two or more carbon atoms in the reformed gas flowing out of the reformer 2 becomes lower than the concentration of the hydrocarbon having two or more carbon atoms in the mixed gas flowing into the reformer 2. The reformed gas flowing out of the reformer 2 flows through the reformed gas line 7 and flows into the reactor 3, but when the heat exchanger 14 is provided, the reformed gas is heated by an operation described later in the heat exchanger 14 and then flows into the reactor 3.

The reformed gas flowing into the reactor 3 passes through the second catalyst 10 while being in contact with the second catalyst 10 (contact step in the method for direct decomposition of a hydrocarbon). At this time, the hydrocarbon in the reformed gas is directly decomposed into hydrogen and carbon. For example, when methane is used as the hydrocarbon in the direct decomposition reaction, a reaction represented by the following chemical equation (5) occurs in the reactor 3.

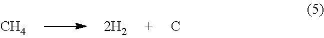

The principle of maintaining the activity of the direct decomposition reaction for a long time is described in detail in Patent Document 1 by the applicant of the present disclosure. To directly accelerate the direct decomposition reaction, the temperature of the second catalyst 10 is similarly preferably maintained in a range of from 600° C. to 900° C. by the heater 18.

The carbon produced by the direct decomposition method adheres to the second catalyst 10, and the produced hydrogen flows out of the reactor 3 as a produced gas together with an unreacted hydrocarbon and flows through the produced gas line 8. When the heat exchanger 14 is provided, in the heat exchanger 14, the produced gas flowing through the produced gas line 8 is cooled by heat exchange with the reformed gas flowing through the reformed gas line 7, and the reformed gas is heated. In addition, in a case where the produced gas line 8 is provided with the solid-gas separator 13, solid matter such as fine powder of carbon entrained in the produced gas is recovered, and a content of the solid matter in the produced gas is reduced. Further, when the gas cooler 11 is provided, the produced gas is cooled by heat exchange with the raw material gas or mixed gas flowing through the raw material gas line 5 in the gas cooler 11, and the raw material gas or mixed gas is heated. Further, when the produced gas line 8 is provided with the gas separator 12, an unreacted hydrocarbon is separated from the produced gas, and a produced gas with an increased hydrogen concentration is supplied as a product gas to a hydrogen storage device or hydrogen consumption device (not shown).

In a case where the gas separator 12 is provided, the unreacted hydrocarbon separated from the produced gas flows through the recycling line 4 depending on the positional relationship between the gas separator 12 and the recycling line 4. In this case, the gas flowing through the recycling line 4 contains an unreacted hydrocarbon as a main component but also contains a small amount of hydrogen, and therefore, although the concentrations of the respective components in the mixed gas flowing into the reactor 3 are different, the types of the components present are the same as those in a case where the gas separator 12 is not provided in the produced gas line 8.

The recovery of carbon can be performed by causing carbon and the carbon adhered to the second catalyst 10 to flow out of the reactor 3 via the carbon outflow line 9. A content of the second catalyst 10 contained in the carbon can be reduced by separating the recovered carbon into carbon and the second catalyst 10 by a carbon remover (not shown) as necessary.

As described above, according to the apparatus 1 for direct decomposition of a hydrocarbon of the present disclosure, a part of the produced gas is supplied to the reformer 2 via the recycling line 4. Since the produced gas contains hydrogen produced by the direct decomposition reaction of the hydrocarbon in the reactor 3, hydrogen is supplied to the reformer 2 by supplying a part of the produced gas to the reformer 2. While hydrogen is required for methanation of the hydrocarbon having two or more carbon atoms in the reformer 2, hydrogen is supplied to the reformer 2, and thus methanation can be caused in the reformer 2. Hence, when a raw material gas containing the hydrocarbon having two or more carbon atoms is used as a raw material for a direct decomposition reaction of a hydrocarbon, the amount of the hydrocarbon having two or more carbon atoms in the raw material gas can be reduced, and therefore, the risk (e.g., clogging of piping) caused by side reactions such as thermal decomposition and polymerization reactions of the hydrocarbon having two or more carbon atoms can be suppressed. In addition, by recycling a part of the produced gas (supplying a part of the produced gas to the reformer 2 through the recycling line 4), it is possible to omit external installation of a new supply device for supplying hydrogen necessary for methanation to the reformer 2, and also to reduce the cost.

In a case where the flow rate adjuster 15 is provided in the recycling line 4, a mixing ratio of the raw material gas and the produced gas, and therefore the concentration ratio between the hydrocarbon having two or more carbon atoms and hydrogen in the mixed gas, can be controlled by adjusting the flow rate of the produced gas flowing through the recycling line 4 by the flow rate adjuster 15. For example, in the case of increasing a proportion of hydrogen in the mixed gas, the flow rate of the produced gas flowing through the recycling line 4 may be increased, and in the case of decreasing the proportion of hydrogen in the mixed gas, the flow rate of the produced gas flowing through the recycling line 4 may be decreased. In this way, since the amount of hydrogen required for methanation can be supplied to the reformer 2, the amount of the hydrocarbon having two or more carbon atoms in the raw material gas can be reduced.

In a case where the concentration ratio acquisition device 16 is provided in the raw material gas line 5 in addition to the flow rate adjuster 15, the flow rate of the produced gas flowing through the recycling line 4 can be adjusted by the flow rate adjuster 15 based on the detection value by the concentration ratio acquisition device 16. For example, when the detection value by the concentration ratio acquisition device 16 exceeds the upper limit value of the range preset in the control system 17, the flow rate of the produced gas flowing through the recycling line 4 is decreased, and when the detection value by the concentration ratio acquisition device 16 falls below the lower limit value of the range preset in the control system 17, the flow rate of the produced gas flowing through the recycling line 4 is increased. In this way, the flow rate adjuster 15 can adjust the flow rate of the produced gas to be supplied to the reformer 2 based on the concentration ratio acquired by the concentration ratio acquisition device 16, and therefore the amount of hydrogen required for methanation can be appropriately supplied to the reformer 2. As a result, the amount of the hydrocarbon having two or more carbon atoms in the raw material gas can be appropriately reduced.

According to the chemical equations (1) to (4), one molecule of hydrogen is required to convert one molecule of ethane into methane, two molecules of hydrogen are required in the case of ethylene and propane, and three molecules of hydrogen are required in the case of butane. Then, if the hydrocarbon having two or more carbon atoms is only ethane, the concentration ratio of hydrogen to the hydrocarbon having two or more carbon atoms needs to be at least 1. Normally, not only ethane but also ethylene, propane, butane, and other hydrocarbons are contained as the hydrocarbons having two or more carbon atoms, and therefore it is necessary to set the concentration ratio of hydrogen to the hydrocarbons having two or more carbon atoms to 1 or more in the reformer 2 to stoichiometrically convert the hydrocarbons having two or more carbon atoms into methane. Such a concentration ratio can be realized by the operation using the flow rate adjuster 15 and the concentration ratio acquisition device 16 described above.

When methanation continues in the reformer 2, the first catalyst 6 may deteriorate due to products produced by side reactions such as thermal decomposition and polymerization reactions of the hydrocarbon having two or more carbon atoms. In such a case, the flow rate of the produced gas flowing through the recycling line 4 is increased by the operation using the flow rate adjuster 15 and the concentration ratio acquisition device 16 described above so that the concentration ratio of hydrogen to the hydrocarbon having two or more carbon atoms increases. As a result, the first catalyst 6 can be regenerated. The fact that the effect of regenerating the first catalyst 6 is obtained by the increase in concentration ratio as described above will be verified in Examples described later. Further, for example, when it can be expected that the proportion of hydrocarbons with a large number of carbon atoms as the hydrocarbons having two or more carbon atoms will be increased by switching the raw material gas, or the like, it is possible to suppress deterioration of the first catalyst 6 by raising the concentration ratio of hydrogen to the hydrocarbons having two or more carbon atoms in advance.

### EXAMPLES

### Example 1

The inventors of the present disclosure conducted a verification experiment of methanation of ethane using a supported catalyst in which ruthenium was supported on alumina as a catalyst corresponding to the first catalyst 6 described above. The supported catalyst of Example 1 is constituted by an aggregate of columnar particles having a diameter of 3 mm and a length of 3 mm, in which 1 part by weight of ruthenium is supported on 100 parts by weight of an alumina carrier.

The supported catalyst of Example 1 was prepared by the following procedure. Ruthenium chloride was weighed in an amount of 1 part by weight in terms of ruthenium with respect to 100 parts by weight of alumina (N611) powder available from Nikki Chemical Co., Ltd., and dissolved in 100 parts by weight of water to prepare an aqueous ruthenium chloride solution. The aqueous ruthenium chloride solution was added dropwise to the alumina powder and impregnated into the alumina powder while stirring, moisture was volatilized while stirring at 110° C., and ruthenium was supported on alumina. After the moisture was completely volatilized, the ruthenium-supported alumina was heated in air at 500° C. for 5 hours to volatilize the remaining chlorine. The supported catalyst in the form of powder thus obtained was molded into the above-described columnar shape by a tablet molding machine.

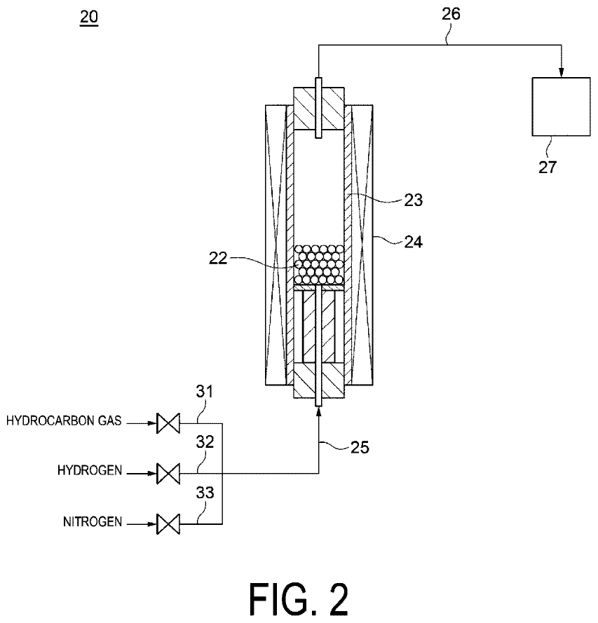

Next, the configuration of an experimental apparatus used for the experiment of Example 1 is shown in FIG. 2. An experimental apparatus 20 is provided with a reactor 23 which is made of quartz, has an inner diameter of 22 mm, and houses a catalyst 22 of Example 1 prepared by the above-described procedure. The reactor 23 can be heated by an electric furnace 24. A raw material gas line 25 for supplying a raw material gas to the reactor 23 is connected to the reactor 23. A hydrocarbon gas supply line 31, a hydrogen supply line 32, and a nitrogen supply line 33 are connected to an upstream end of the raw material gas line 25, and any one of ethane as a hydrocarbon gas, hydrogen, and nitrogen, or a mixed gas in which some of these are mixed is supplied as a raw material gas to the reactor 23 via the raw material gas line 25. A produced gas line 26 through which a produced gas containing methane produced by methanation of ethane flows after flowing out of the reactor 23 is connected to the reactor 23. The produced gas line 26 is connected to a gas chromatography 27 for measuring the composition of the produced gas.

Next, an experimental method of Example 1 will be described. After 2.4 cc of the catalyst 22 was housed in the reactor 23, the catalyst 22 was heated to 400° C. by the electric furnace 24. After the temperature of the catalysts 22 was raised to 400° C., a raw material gas containing 10 vol % of hydrogen and 90 vol % of nitrogen gas was caused to flow through the reactors 23 at a flow rate of 40 cc/min (space velocity: 1000 hr⁻¹) for 3 hours to perform an activation treatment of the catalyst 22. After the activation treatment was completed, the electric furnace 24 was adjusted to lower the temperature of the catalyst 22 to 300° C., and then the flow rates of ethane and hydrogen were respectively set to 20 cc/min, whereby a raw material gas containing ethane and hydrogen at a concentration ratio of 1:1, that is, containing 50 vol % of ethane and 50 vol % of hydrogen, was caused to flow through the reactor 23 at a flow rate of 40 cc/min, and the methanation of ethane was started. After an elapse of 17 hours from the start of methanation, the temperature of the catalyst 22 was raised to 400° C. by the electric furnace 24, and this state was maintained until 20 hours had elapsed from the start of methanation. Next, the electric furnace 24 was adjusted to lower the temperature of the catalyst 22 to 300° C., and this state was maintained until 23 hours had elapsed from the start of methanation. Next, the flow rate of hydrogen was increased from 20 cc/min to 40 cc/min, thereby causing the raw material gas containing ethane and hydrogen at a concentration ratio of 1:2 to flow through the reactor 23 at a flow rate of 60 cc/min (space velocity: 1500 hr⁻¹), and this state was maintained until 25 hours had elapsed from the start of methanation. The composition of the produced gas was measured by gas chromatography 27 until 25 hours had elapsed from the start of methanation.

The conversion rate of ethane was calculated from the composition of the produced gas by the following formula (6).

$$Conversion rate of ethane = ( 1 - {m}_{C 2 H 6 \_ out} / {m}_{C 2 H 6 \_ in} ) \times 100 \qquad ( 6 )$$

In the formula (6), m_{C2H6_out} is the flow rate of ethane in the produced gas, and m_{C2H6_in} is the amount of ethane in the raw material gas.

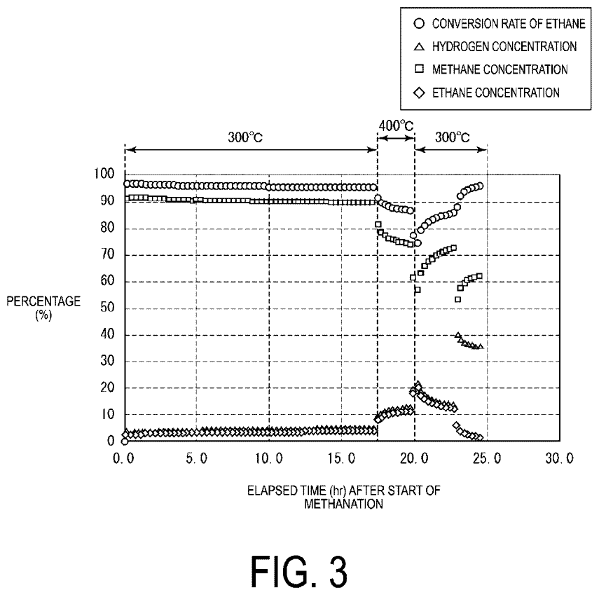

FIG. 3 shows changes, with time, in concentrations of hydrogen, methane, and ethane in the produced gas and in conversion rate of ethane, until 25 hours had elapsed from the start of methanation, in the experiment of Example 1. The conversion rate of ethane was stably maintained at about 96% until 17 hours had elapsed from the start of methanation. Thereafter, when the temperature of the catalyst 22 was raised to 400° C., the conversion rate of ethane decreased to 87% within 20 hours after the start of methanation. Thereafter, when the temperature of the catalyst 22 was lowered to 300° C., the conversion rate of ethane temporarily decreased to less than 80%, but then increased again, and recovered to 85% after 23 hours from the start of methanation.

From the results so far, it was found that the methanation activity was good at the initial stage of methanation, but that the methanation activity was decreased as the temperature of the catalyst 22 was increased from 300° C. to 400° C. Further, it was revealed that the methanation activity was significantly decreased due to the decrease in temperature of the catalyst 22 from 400° C. to 300° C., and deterioration of the catalyst 22 was confirmed. It could be confirmed, from the results of the composition analysis of the produced gas, that the reaction represented by the chemical equation (1) proceeded substantially stoichiometrically until 17 hours had elapsed from the start of methanation.

Further, by setting the concentration ratio between ethane and hydrogen to 1:2 after 23 hours had elapsed from the start of methanation, the conversion rate of ethane was recovered to 95% or more after 25 hours had elapsed from the start of methanation. The catalyst 22 may deteriorate with time because a by-product produced by a side reaction such as a polymerization reaction of ethane adheres to a surface of the catalyst 22. It is probable that the by-product adhering to the surface of the catalyst 22 is decomposed and removed by increasing the concentration of hydrogen in the raw material gas, and that the catalyst 22 is regenerated. In addition, it is probable that, under conditions where the catalyst 22 is expected to deteriorate, the deterioration of the catalyst 22 can be suppressed by increasing the concentration of hydrogen in the raw material gas in advance.

### Example 2

The inventors of the present disclosure conducted a verification experiment of methanation of ethane using a supported catalyst in which nickel was supported on alumina as a catalyst corresponding to the first catalyst 6 described above. The supported catalyst of Example 2 is constituted by an aggregate of columnar particles having a diameter of 3 mm and a length of 3 mm, in which 30 parts by weight of nickel is supported on 100 parts by weight of an alumina carrier.

The supported catalyst of Example 2 was prepared by the following procedure. Nickel nitrate was weighed in an amount of 30 parts by weight in terms of nickel with respect to 100 parts by weight of alumina (N611) powder available from Nikki Chemical Co., Ltd., and dissolved in 100 parts by weight of water to prepare an aqueous nickel nitrate solution. The aqueous nickel nitrate solution was added dropwise to the alumina powder and impregnated into the alumina powder while stirring continuously, moisture was volatilized while stirring at 110° C., and nickel oxide was supported on alumina. After the moisture was completely volatilized, the nickel oxide-supported alumina was heated in air at 500° C. for 5 hours to decompose the remaining nitrate. The supported catalyst in the form of powder thus obtained was molded into the above-described columnar shape by a tablet molding machine.

Next, an experimental method of Example 2 will be described. After 2.4 cc of the catalyst 22 of Example 2 prepared by the above-described procedure was housed in the reactor 23, the activation treatment of the catalyst 22 was performed in the same manner as in Example 1. After the activation treatment was completed, the electric furnace 24 was adjusted to lower the temperature of the catalyst 22 to 130° C., and then the flow rates of ethane and hydrogen were respectively set to 20 cc/min, whereby a raw material gas containing ethane and hydrogen at a concentration ratio of 1:1, that is, containing 50 vol % of ethane and 50 vol % of hydrogen, was caused to flow through the reactor 23 at a flow rate of 40 cc/min (space velocity: 1000 hr⁻¹), and the methanation of ethane was started. The temperature of the catalyst 22 was raised to 200° C. after an elapse of 1 hour from the start of methanation, then the temperature of the catalyst 22 was raised to 300° C. after an elapse of 2 hours from the start of methanation, and this state was maintained until 18 hours had elapsed from the start of methanation.

After an elapse of 18 hours from the start of methanation, the temperature of the catalyst 22 was raised to 400° C., and this state was maintained until 22 hours had elapsed from the start of methanation. Next, after an elapse of 22 hours from the start of methanation, the temperature of the catalyst 22 was lowered to 300° C., and this state was maintained until 25 hours had elapsed from the start of methanation. Next, after an elapse of 25 hours from the start of methanation, the temperature of the catalyst 22 was raised to 500° C., and this state was maintained until 28 hours had elapsed from the start of methanation. Next, after an elapse of 28 hours from the start of methanation, the temperature of the catalyst 22 was lowered to 300° C., and this state was maintained until 44 hours had elapsed from the start of methanation. Next, after an elapse of 44 hours from the start of methanation, the flow rate of hydrogen was increased from 20 cc/min to 40 cc/min, thereby causing the raw material gas having a concentration ratio between ethane and hydrogen of 1:2 to flow through the reactor 23 at a flow rate of 60 cc/min (space velocity: 1500 hr⁻¹), and this state was maintained until 48 hours had elapsed from the start of methanation. Next, after an elapse of 48 hours from the start of methanation, the flow rate of hydrogen was decreased from 40 cc/min to 20 cc/min, thereby causing the raw material gas having a concentration ratio between ethane and hydrogen of 1:1 to flow through the reactor 23 at a flow rate of 40 cc/min (space velocity: 1000 hr⁻¹), and this state was maintained until 50 hours had elapsed from the start of methanation. The composition of the produced gas was measured by gas chromatography 27 until 50 hours had elapsed from the start of methanation.

The conversion rate of ethane was calculated from the composition of the produced gas by the formula (6), and the selectivity for methane was calculated by the following formula (7).

$$Selectivity for methane = {m}_{CH 4 \_ out} / ( 2 \times ( {m}_{C 2 H 6 \_ in} - {m}_{C 2 H 6 \_ out} ) ) \times 100 \qquad ( 7 )$$

In the formula (7), m_{CH4_out} is the flow rate of methane in the raw material gas.

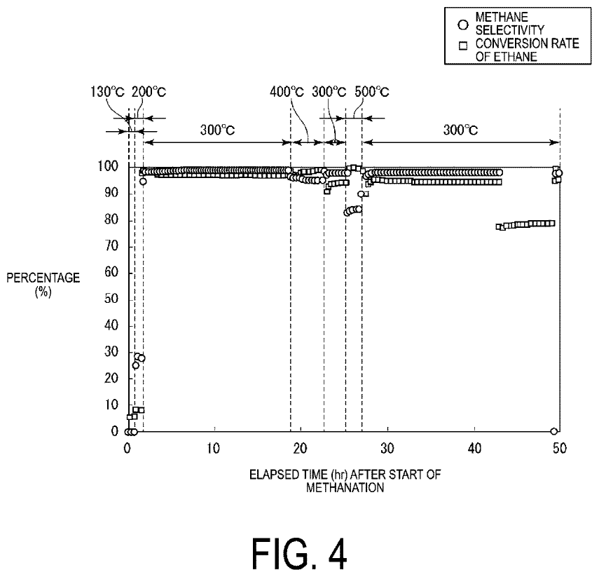

FIG. 4 shows changes, with time, in conversion rate of ethane and in selectivity for methane until 50 hours had elapsed from the start of methanation, in the experiment of Example 2. According to the change in conversion rate of ethane with time, it was found that methanation hardly occurred under the conditions where the temperature of the catalyst 22 was 130° C. and 200° C., and that methanation occurred by raising the temperature of the catalyst 22 to 300° C. Under the condition where the temperature of the catalyst 22 was 300° C., a high activity with a conversion rate of ethane of about 98% was stably obtained and a high selectivity for methane of about 99% was also stably obtained, until 18 hours after the start of methanation. Thereafter, also under the condition where the temperature of the catalyst 22 was raised to 400° C., a high activity with a conversion rate of ethane of about 99% was stably obtained and a high selectivity for methane of about 96% was also stably obtained, until 22 hours after the start of methanation. Further, thereafter, also under the condition where the temperature of the catalyst 22 was lowered to 300° C., a high activity with a conversion rate of ethane of about 95% was stably obtained and a high selectivity for methane of about 99% was also stably obtained, until 25 hours after the start of methanation. Further, under the condition where the temperature of the catalyst 22 was raised to 500° C., a high activity with a conversion rate of ethane of about 100% was stably obtained and a relatively high state with a selectivity for methane of about 85% was obtained although the selectivity for methane was slightly lowered, until 28 hours after the start of methanation. As described above, until 28 hours after the start of methanation, both the conversion rate of ethane and the selectivity for methane showed good results under the condition where the temperature of the catalyst 22 was from 300 to 500° C., and no deterioration of the catalyst 22 was confirmed.

After the temperature of the catalyst 22 was lowered to 300° C. after an elapse of 28 hours from the start of methanation, the conversion rate of ethane gradually decreased, and after an elapse of 44 hours from the start of methanation, the conversion rate of ethane became about 90%, and therefore, it was determined that the catalyst 22 started to deteriorate or might deteriorate. Therefore, when the state in which the concentration ratio between ethane and hydrogen in the raw material gas was changed to 1:2 was continued for 4 hours and then the state in which the concentration ratio between ethane and hydrogen in the raw material gas was returned to 1:1 was continued for 2 hours, the conversion rate of ethane was recovered to 96%. Also from the results, it is deducible that regeneration of the catalyst 22 and suppression of the deterioration thereof can be done by increasing the concentration of hydrogen in the raw material gas.

### Example 3

The inventors of the present disclosure conducted an experiment of Example 3 using the catalyst 22 of Example 2 and using CNG as the hydrocarbon gas. The CNG used in Example 3 is a general desulfurized city gas, and its typical composition is as follows: 89.9 vol % of methane, 4.4 vol % of ethane, 4.6 vol % of propane, 1.0 vol % of butane, and 0.1 vol % of other components such as nitrogen.

Next, an experimental method of Example 3 will be described. After 2.4 cc of the catalyst 22 of Example 2 was housed in the reactor 23, the activation treatment of the catalyst 22 was performed in the same manner as in Example 2. After the activation treatment was completed, the electric furnace 24 was adjusted to lower the temperature of the catalyst 22 to 250° C., and then the flow rates of CNG and hydrogen were adjusted to 59 cc/min and 16 cc/min, respectively, so that the concentration ratio of hydrogen to the hydrocarbon having two or more carbon atoms was 1.5, based on the typical composition of the city gas, and the raw material gas, which was a mixture of CNG and hydrogen, was caused to flow through the reactor 23 at a flow rate of 75 cc/min (space velocity: 930 hr⁻¹) to start methanation of the hydrocarbon having two or more carbon atoms. The temperature of the catalyst 22 was raised to 300° C. 3 hours after the start of methanation, the temperature of the catalyst 22 was raised to 400° C. 5 hours after the start of methanation, and the temperature of the catalyst 22 was lowered to 300° C. 9 hours after the start of methanation.

Next, 23 hours after the start of methanation, the flow rates of CNG and hydrogen were increased to 320 cc/min and 80 cc/min, respectively, while the temperature of the catalysts 22 and the concentration ratio of hydrogen to the hydrocarbon having two or more carbon atoms were kept unchanged, thereby increasing the flow rate of the raw material gas to 400 cc/min (the space velocity to 5000 hr⁻¹). Thereafter, the temperature of the catalyst 22 was raised to 400° C. 26 hours after the start of methanation, the temperature of the catalyst 22 was raised to 500° C. 29 hours after the start of methanation, the temperature of the catalyst 22 was lowered to 300° C. 31 hours after the start of methanation, and this state was maintained until 34 hours had elapsed from the start of methanation. The composition of the produced gas was measured by gas chromatography 27 until 34 hours had elapsed from the start of methanation.

From the composition of the produced gas, the selectivity for methane was calculated by the formula (7), and the conversion rate of the hydrocarbon having two or more carbon atoms was calculated by the following formula (8).

$$Conversion rate of hydrocarbon having two or more carbon atoms = ( 1 - {m}_{C 2 + \_ out} / {m}_{C 2 + \_ in} ) \times 100 \qquad ( 8 )$$

In the formula (8), m_{C2+_out} is the flow rate of the hydrocarbon having two or more carbon atoms in the produced gas, and m_{C2+_in} is the amount of the hydrocarbon having two or more carbon atoms in the raw material gas.

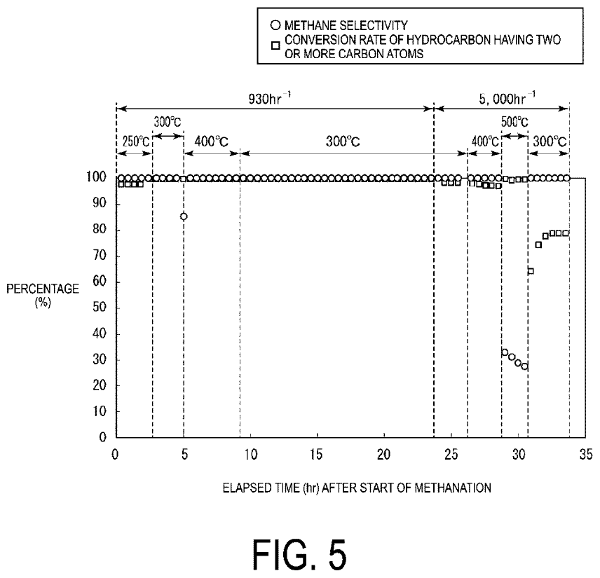

FIG. 5 shows changes, with time, in conversion rate of the hydrocarbon having two or more carbon atoms and the selectivity for methane until 34 hours had elapsed from the start of methanation, in the experiment of Example 3. Until 23 hours after the start of methanation, that is, when the temperature of the catalyst 22 was in a range of from 250 to 400° C. under the condition where the space velocity of the raw material gas was 930 hr⁻¹, the conversion rate of the hydrocarbon having two or more carbon atoms and the selectivity for methane were about 100%. Also, after 23 hours from the start of methanation, that is, when the temperature of the catalyst 22 was in a range of from 300 to 500° C. under the condition where the space velocity of the raw material gas was 5000 hr⁻¹, the conversion rate of the hydrocarbon having two or more carbon atoms was 97% or more and the selectivity for methane was about 100%. From the results so far, it was found that when the space velocity of the raw material gas was in a range of from 930 to 5000 hr⁻¹ and the temperature of the catalyst 22 was in a range of from 250 to 500° C., even if CNG was used as the raw material gas, high methanation activity was obtained as in a case where ethane was used as the raw material gas.

However, after the temperature of the catalyst 22 was raised to 500° C., the selectivity for methane decreased to 30% or less, and after an elapse of 31 hours from the start of methanation, the conversion rate of the hydrocarbon having two or more carbon atoms decreased to about 60%. Further, since an increase in concentration of hydrogen in the produced gas was also observed at this timing, it is deducible that the direct decomposition reaction of methane represented by the chemical equation (5) was also caused under this condition (the condition where the temperature of the catalyst 22 was 500° C.).

Thereafter, the temperature of the catalyst 22 was lowered to 300° C. after an elapse of 31 hours from the start of methanation, but the conversion rate of the hydrocarbon having two or more carbon atoms gradually increased, but recovered only to about 70% within 34 hours after the start of methanation. That is, deterioration of the catalyst 22 was confirmed. The cause of this deterioration is presumed to be that when the temperature of the catalyst 22 is high (specifically, 500° C.), the catalyst 22 is poisoned by carbon produced by the direct decomposition reaction of methane.

### Example 4

The inventors of the present disclosure conducted a verification experiment of Example 4 in which the space velocity of the raw material gas was set to 10000 hr⁻¹ relative to Example 3. After 2.4 cc of the catalyst 22 of Example 2 was housed in the reactor 23, the activation treatment of the catalyst 22 was performed in the same manner as in Example 2. After the activation treatment was completed, the electric furnace 24 was adjusted to lower the temperature of the catalyst 22 to 250° C., and then the flow rates of CNG and hydrogen were adjusted to 640 cc/min and 160 cc/min, respectively, so that the concentration ratio of hydrogen to the hydrocarbon having two or more carbon atoms was 1.5, based on the typical composition of the city gas, and the raw material gas, which was a mixture of CNG and hydrogen, was caused to flow through the reactor 23 at a flow rate of 800 cc/min (space velocity: 10000 hr⁻¹) to start methanation of the hydrocarbon having two or more carbon atoms.

The temperature of the catalyst 22 was raised to 300° C. 2.5 hours after the start of methanation, the temperature of the catalyst 22 was lowered to 250° C. 25 hours after the start of methanation, the temperature of the catalyst 22 was raised to 300° C. 27.5 hours after the start of methanation, the temperature of the catalyst 22 was lowered to 250° C. 95 hours after the start of methanation, the temperature of the catalyst 22 was raised to 300° C. 97.5 hours after the start of methanation, and this state was maintained until 100 hours had elapsed from the start of methanation. The composition of the produced gas was measured by gas chromatography 27 until 100 hours had elapsed from the start of methanation.

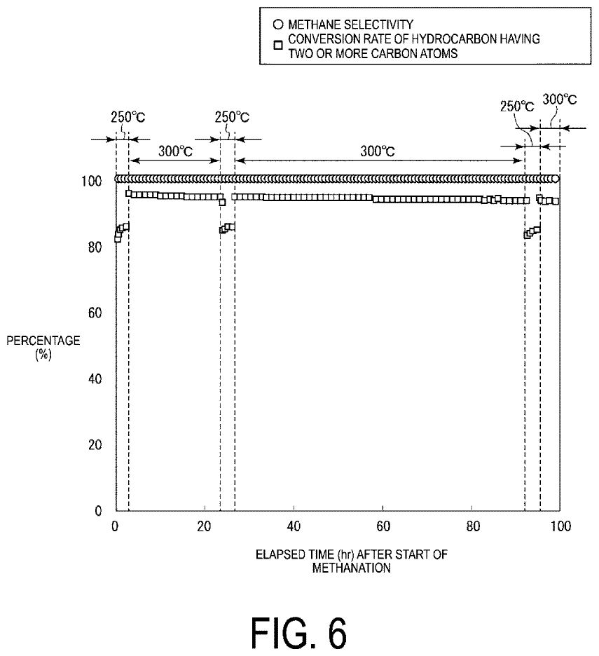

FIG. 6 shows changes, with time, in conversion rate of the hydrocarbon having two or more carbon atoms and the selectivity for methane until 100 hours had elapsed from the start of methanation, in the experiment of Example 4. When the temperature of the catalyst 22 was 250° C. for 100 hours after the start of methanation, the conversion rate of the hydrocarbon having two or more carbon atoms was from 83 to 84%, and the selectivity for methane was about 100%. When the temperature of the catalyst 22 was 300° C., the conversion rate of the hydrocarbon having two or more carbon atoms was from 93 to 94%, and the selectivity for methane was about 100%. Under the conditions of Example 4, no deterioration of the catalyst 22 was observed for 100 hours after the start of methanation, and the conversion rate of the hydrocarbon having two or more carbon atoms also showed a relatively stably high value.

The contents described in the above embodiments are understood, for example, as follows.

[1] An apparatus for direct decomposition of a hydrocarbon according to an aspect is an apparatus (1) for direct decomposition of a hydrocarbon, which directly decomposes a hydrocarbon into carbon and hydrogen using a gas containing methane and a hydrocarbon having two or more carbon atoms as a raw material gas, the apparatus including:
a reformer (2) that houses a first catalyst (6) for methanation of the hydrocarbon having two or more carbon atoms;
a reactor (3) which is configured so that a reformed gas flowing out of the reformer (2) flows into the reactor, and which houses a second catalyst (10) that is an iron-based catalyst; and
a recycling line (4) that connects a produced gas line (8) through which a produced gas flowing out of the reactor (3) flows, to a raw material gas line (5) for introducing the raw material gas into the reformer (2).

According to the apparatus for direct decomposition of a hydrocarbon of the present disclosure, a part of the produced gas is supplied to the reformer via the recycling line. Since the produced gas contains hydrogen produced by the direct decomposition reaction of the hydrocarbon in the reactor, hydrogen is supplied to the reformer by supplying a part of the produced gas to the reformer. While hydrogen is required for methanation of the hydrocarbon having two or more carbon atoms in the reformer, hydrogen is supplied to the reformer, and thus methanation can be caused in the reformer. Hence, when a raw material gas containing a hydrocarbon having two or more carbon atoms is used as a raw material for a direct decomposition reaction of a hydrocarbon, the amount of the hydrocarbon having two or more carbon atoms in the raw material gas can be reduced, and therefore, the risk caused by side reactions such as thermal decomposition and polymerization reactions of the hydrocarbon having two or more carbon atoms can be suppressed.

[2] An apparatus for direct decomposition of a hydrocarbon according to another aspect is the apparatus for direct decomposition of a hydrocarbon according to [1], wherein
the recycling line (4) is provided with a flow rate adjuster (15) for adjusting a flow rate of the produced gas flowing through the recycling line (4).

According to such a configuration, the amount of hydrogen required for methanation can be supplied to the reformer, and thus the amount of the hydrocarbon having two or more carbon atoms in the raw material gas can be reduced.

[3] An apparatus for direct decomposition of a hydrocarbon according to yet another aspect is the apparatus for direct decomposition of a hydrocarbon according to [2], further including a concentration ratio acquisition device (16) that acquires a concentration ratio between the hydrocarbon having two or more carbon atoms and hydrogen in the raw material gas to which the produced gas has been supplied via the recycling line (4).

According to such a configuration, the flow rate adjuster can adjust the flow rate of the produced gas to be supplied to the reformer based on the concentration ratio acquired by the concentration ratio acquisition device, and therefore the amount of hydrogen required for methanation can be appropriately supplied to the reformer. As a result, the amount of the hydrocarbon having two or more carbon atoms in the raw material gas can be appropriately reduced.

[4] An apparatus for direct decomposition of a hydrocarbon according to still another aspect is the apparatus for direct decomposition of a hydrocarbon according to any one of [1] to [3], wherein
the first catalyst (6) is a supported catalyst in which ruthenium or nickel is supported on alumina.

According to such a configuration, when a raw material gas containing a hydrocarbon having two or more carbon atoms is used as a raw material for the direct decomposition reaction of a hydrocarbon, it is possible to remove the hydrocarbon having two or more carbon atoms from the raw material gas.

[5] A method for direct decomposition of a hydrocarbon according to an aspect is a method for direct decomposition of a hydrocarbon, which directly decomposes a hydrocarbon into carbon and hydrogen using a gas containing methane and a hydrocarbon having two or more carbon atoms as a raw material gas, the method including:
a methanation step of converting the hydrocarbon having two or more carbon atoms into methane;
a contact step of bringing a reformed gas obtained in the methanation step into contact with an iron-based catalyst (second catalyst 10); and
a recycle step of supplying a part of a produced gas obtained in the contact step to the raw material gas.

According to the method for direct decomposition of a hydrocarbon of the present disclosure, a part of the produced gas is used in the methanation step. Since the produced gas contains hydrogen produced by the direct decomposition reaction of the hydrocarbon in the contact step, hydrogen is present in the methanation step. While hydrogen is required for methanation of the hydrocarbon having two or more carbon atoms, hydrogen is present in the methanation step, and thus methanation can be caused. Hence, when a raw material gas containing a hydrocarbon having two or more carbon atoms is used as a raw material for a direct decomposition reaction of a hydrocarbon, the amount of the hydrocarbon having two or more carbon atoms in the raw material gas can be reduced, and therefore, the risk caused by side reactions such as thermal decomposition and polymerization reactions of the hydrocarbon having two or more carbon atoms can be suppressed.

[6] A method for direct decomposition of a hydrocarbon according to another aspect is the method for direct decomposition of a hydrocarbon according to [5], wherein
the recycle step includes a step of adjusting a flow rate of the produced gas to be supplied to the raw material gas.

According to such a method, the amount of hydrogen required for methanation can be present in the methanation step, and thus the amount of the hydrocarbon having two or more carbon atoms in the raw material gas can be reduced.

[7] A method for direct decomposition of a hydrocarbon according to yet another aspect is the method for direct decomposition of a hydrocarbon according to [6], wherein
the recycle step further includes a step of acquiring a concentration ratio between the hydrocarbon having two or more carbon atoms and hydrogen in the raw material gas to which the produced gas has been supplied, and
the flow rate of the produced gas to be supplied to the raw material gas is adjusted based on the acquired concentration ratio.

According to such a method, the flow rate of the produced gas to be supplied to the methanation step can be adjusted based on the acquired concentration ratio, and thus, the amount of hydrogen required for methanation can be appropriately present in the methanation step. As a result, the amount of the hydrocarbon having two or more carbon atoms in the raw material gas can be appropriately reduced.

[8] A method for direct decomposition of a hydrocarbon according to still another aspect is the method for direct decomposition of a hydrocarbon according to [7], wherein
the flow rate of the produced gas to be supplied to the raw material gas is adjusted so that the concentration ratio of hydrogen to the hydrocarbon having two or more carbon atoms is 1 or more.

To convert ethane, which has the lowest number of carbon atoms, among the hydrocarbons having two or more carbon atoms, into methane, one molecule of hydrogen is required for one molecule of ethane. Therefore, according to such a method, the hydrocarbon having two or more carbon atoms in the raw material gas can be stoichiometrically converted into methane.

[9] A method for direct decomposition of a hydrocarbon according to still another aspect is the method for direct decomposition of a hydrocarbon according to [8], wherein
the flow rate of the produced gas to be supplied to the raw material gas is adjusted so that the concentration ratio of hydrogen to the hydrocarbon having two or more carbon atoms increases.

According to such a method, it is possible to suppress the deterioration of the catalyst for methanation due to a product produced by side reactions such as thermal decomposition and polymerization reactions of the hydrocarbon having two or more carbon atoms, or it is possible to regenerate the deteriorated catalyst.

[10] A method for direct decomposition of a hydrocarbon according to still another aspect is the method for direct decomposition of a hydrocarbon according to any one of [5] to [9], wherein
the methanation step is performed in a temperature range of from 250 to 500° C. and a space velocity of from 930 to 10000 hr⁻¹.

According to such a method, when a raw material gas containing a hydrocarbon having two or more carbon atoms is used as a raw material for a direct decomposition reaction of a hydrocarbon, the amount of the hydrocarbon having two or more carbon atoms in the raw material gas can be reduced, and therefore, the risk caused by side reactions such as thermal decomposition and polymerization reactions of the hydrocarbon having two or more carbon atoms can be suppressed.

[11] A method for direct decomposition of a hydrocarbon according to still another aspect is the method for direct decomposition of a hydrocarbon according to any one of [5] to [10], wherein
the raw material gas is natural gas, compressed natural gas, city gas, liquefied petroleum gas, or naphtha.

According to such a method, since the hydrocarbon having two or more carbon atoms can be removed from natural gas, compressed natural gas, city gas, liquefied petroleum gas, or naphtha containing the hydrocarbon having two or more carbon atoms, and then the hydrocarbon in the raw material gas can be directly decomposed, it is possible to suppress the risk caused by side reactions such as thermal decomposition and polymerization reactions of the hydrocarbon having two or more carbon atoms.

### REFERENCE SIGNS LIST

1: Direct decomposition apparatus
2: Reformer
3: Reactor
4: Recycling line
5: Raw material gas line
6: First catalyst
8: Produced gas line
10: Second catalyst
15: Flow rate adjuster
16: Concentration ratio acquisition device

1. An apparatus for direct decomposition of a hydrocarbon, which directly decomposes a hydrocarbon into carbon and hydrogen using a gas containing methane and a hydrocarbon having two or more carbon atoms as a raw material gas, the apparatus comprising:
a reformer that houses a first catalyst for methanation of the hydrocarbon having two or more carbon atoms;
a reactor which is configured so that a reformed gas flowing out of the reformer flows into the reactor, and which houses a second catalyst that is an iron-based catalyst; and
a recycling line that connects a produced gas line through which a produced gas flowing out of the reactor flows, to a raw material gas line for introducing the raw material gas into the reformer.

2. The apparatus for direct decomposition of a hydrocarbon according to claim 1, wherein the recycling line is provided with a flow rate adjuster for adjusting a flow rate of the produced gas flowing through the recycling line.

3. The apparatus for direct decomposition of a hydrocarbon according to claim 2, further comprising a concentration ratio acquisition device that acquires a concentration ratio between the hydrocarbon having two or more carbon atoms and hydrogen in the raw material gas to which the produced gas has been supplied via the recycling line.

4. The apparatus for direct decomposition of a hydrocarbon according to claim 1, wherein the first catalyst is a supported catalyst in which ruthenium or nickel is supported on alumina.

5. A method for direct decomposition of a hydrocarbon, which directly decomposes a hydrocarbon into carbon and hydrogen using a gas containing methane and a hydrocarbon having two or more carbon atoms as a raw material gas, the method comprising:
a methanation step of converting the hydrocarbon having two or more carbon atoms into methane;
a contact step of bringing a reformed gas obtained in the methanation step into contact with an iron-based catalyst; and
a recycle step of supplying a part of a produced gas obtained in the contact step to the raw material gas.

6. The method for direct decomposition of a hydrocarbon according to claim 5, wherein the recycle step comprises a step of adjusting a flow rate of the produced gas to be supplied to the raw material gas.

7. The method for direct decomposition of a hydrocarbon according to claim 6, wherein
the recycle step further comprises a step of acquiring a concentration ratio between the hydrocarbon having two or more carbon atoms and hydrogen in the raw material gas to which the produced gas has been supplied, and
the flow rate of the produced gas to be supplied to the raw material gas is adjusted based on the acquired concentration ratio.

8. The method for direct decomposition of a hydrocarbon according to claim 7, wherein the flow rate of the produced gas to be supplied to the raw material gas is adjusted so that the concentration ratio of hydrogen to the hydrocarbon having two or more carbon atoms is 1 or more.

9. The method for direct decomposition of a hydrocarbon according to claim 8, wherein the flow rate of the produced gas to be supplied to the raw material gas is adjusted so that the concentration ratio of hydrogen to the hydrocarbon having two or more carbon atoms increases.

10. The method for direct decomposition of a hydrocarbon according to claim 5, wherein the methanation step is performed in a temperature range of from 250 to 500° C. and a space velocity of from 930 to 10000 hr⁻¹.

11. The method for direct decomposition of a hydrocarbon according to claim 5, wherein the raw material gas is natural gas, compressed natural gas, city gas, liquefied petroleum gas, or naphtha.
